(19) United States
(12) Patent Application Publication
(10) Pub. No.: US 2025/0147258 A1
(43) Pub. Date: May 8, 2025

(54) OPTICAL FIBER MANAGEMENT TRAY ASSEMBLY WITH IMPROVED ACCESS TO INTERIOR FIBER MANAGEMENT FEATURES

(71) Applicant: CommScope Technologies LLC, Hickory, NC (US)

(72) Inventors: Bart Mattie CLAESSENS, Hasselt (BE); Kurt Thomas FISCHER, Rackwitz (DE)

(73) Assignee: CommScope Technologies LLC, Hickory, NC (US)

(21) Appl. No.: 18/838,063

(22) PCT Filed: Feb. 17, 2023
(86) PCT No.: PCT/US2023/062852

§ 371 Date: Aug. 13, 2024

Related U.S. Application Data
(60) Provisional application No. 63/311,519, filed on Feb. 18, 2022.

(51) Int. Cl. G02B 6/44

(52) U.S. Cl. CPC G02B 6/4455; G02B 6/4447; G02B 6/4454

(57) ABSTRACT

An optical fiber management tray assembly with improved work surface access. The assembly includes a first piece and a second piece pivotally attached to the first piece. The first piece is configured to pivotally attach to a tray support structure. One or more fiber management components are positioned on an interior side of the second piece. The second piece can be pivoted away from the first piece to provide access to the one or more fiber management components.

### CROSS-REFERENCE TO RELATED APPLICATION

This application is being filed on Feb. 17, 2023, as a PCT International application and claims the benefit of and priority to U.S. Patent Application No. 63/311,519 filed on Feb. 18, 2022, the disclosure of which is hereby incorporated by reference in its entirety.

### TECHNICAL FIELD

The present disclosure relates to the management of optical fibers at telecommunications equipment, such as telecommunications closures.

### BACKGROUND

Fiber optic cables can be managed inside a telecommunications closure using an optical fiber management assembly, or organizer. In some closures, the organizer includes pivotally mounted optical fiber management trays that support optical fiber splices, splitters, connectors, adapters, and/or other optical components. Telecommunications enclosures are typically sealable and re-enterable, defining sealed closure volumes. Such closures are often buried underground or aerially suspended from power or communications lines, such that the closures are generally designed to be both weatherproof and as compact as possible. Due to the compactness, access to optical fiber management within the closure and on the optical fiber management trays can be limited.

### SUMMARY

In general terms, the present disclosure is directed to an improved optical fiber management tray.

In further general terms, the present disclosure is directed to an improved optical fiber management tray assembly.

In further general terms, the present disclosure is directed to an improved optical fiber management tray assembly of an organizer assembly (or, simply, “organizer”) for managing optical fibers at telecommunications equipment, such as a telecommunications closure.

In further general terms, the present disclosure is directed to an improved optical fiber closure including one or more optical fiber tray assemblies according to the present disclosure.

In further general terms, the present disclosure is directed to a method of using an optical fiber tray assembly according to the present disclosure to manage one or more optical fibers.

According to certain aspects, the present disclosure is directed to an optical fiber management tray assembly with improved access to interior fiber management features.

According to certain aspects, the present disclosure is directed to an optical fiber management tray assembly that includes a first tray piece configured to be pivotally coupled to a tray support, and a second tray piece that is pivotally coupled to the first tray piece, wherein an interior surface of the second tray piece is configured to manage an optical fiber.

According to certain specific aspects, an optical fiber management tray assembly, includes: a closed configuration defining an assembly interior and an assembly exterior; an access configuration; a first piece configured to pivotally attach to a tray support and including a first interior work surface; and a second piece pivotally attached to the first piece and including a second interior work surface, the first interior work surface and the second interior work surface defining the assembly interior and facing each other when the assembly is in the closed configuration; and a fiber management component integral with or attached to the second interior work surface, the fiber management component being: positioned in the assembly interior when the assembly is in the closed configuration; and accessible when the assembly is in the access configuration.

According to further certain specific aspects, an optical fiber management tray assembly, includes: a closed configuration defining an assembly interior and an assembly exterior; an access configuration; a first piece configured to pivotally attach to a tray support and including a first work surface and a first fiber retaining lip for retaining an optical fiber between the first work surface and the first fiber retaining lip; and a second piece pivotally attached to the first piece at a hinge positioned at or exterior to an outer wall of the second piece and positioned at or exterior to an outer wall of the first piece, the second piece including a second surface and a second fiber retaining lip for retaining the optical fiber between the second work surface and the second fiber retaining lip, wherein the second piece includes a fiber passage for routing the optical fiber through the fiber passage from the first work surface to the second work surface; and wherein the fiber passage is not defined by the hinge.

According to further specific aspects, an optical fiber management tray assembly, including: a closed configuration defining an assembly interior and an assembly exterior; an access configuration; a first piece configured to pivotally attach to a tray support and including a first work surface and a fiber retaining lip for retaining an optical fiber between the first work surface and the fiber retaining lip; and a second piece pivotally attached to the first piece at a hinge positioned at or exterior to an outer wall of the second piece and positioned at or exterior to an outer wall of the first piece; and an adapter integral with or attached to the second piece, the adapter being configured to optically couple optical fibers terminated at optical fiber connectors when the connectors are mounted in the adapter.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of example telecommunications equipment that can support an optical fiber management organizer assembly according to the present disclosure.

FIG. 2 is a further perspective view of the equipment of FIG. 1.

FIG. 3 is a perspective view of an example organizer assembly (or, “organizer”) according to the present disclosure that can be housed in the equipment of FIG. 1.

FIG. 4 is a further perspective view of the organizer of FIG. 3.

FIG. 5 is a perspective view of an embodiment of a fiber management tray assembly according to the present disclosure, the tray assembly being in a closed configuration.

FIG. 6 is a further perspective view of the tray assembly of FIG. 5, the tray assembly being in a closed configuration.

FIG. 7 is a further perspective view of the tray assembly of FIG. 5, the tray assembly being in a closed configuration.

FIG. 8 is a further perspective view of the tray assembly of FIG. 5, the tray assembly being in an access configuration.

FIG. 9 is an exploded view of a portion of the tray assembly of FIG. 5.

FIG. 10 is a perspective view of one of the pieces of the tray assembly of FIG. 5.

FIG. 11 is a further perspective view of the piece of FIG. 10.

FIG. 12 is a perspective view of another of the pieces of the tray assembly of FIG. 5.

FIG. 13 is a further perspective view of the piece of FIG. 12.

FIG. 14 is a further perspective view of the piece of FIG. 12.

FIG. 15 is a further perspective view of the piece of FIG. 12.

FIG. 16 is a perspective view including the tray assembly of FIG. 5 pivotally attached to a tray support of an organizer and in an access configuration.

FIG. 17 is a perspective view of a further embodiment of a fiber management tray assembly according to the present disclosure, the tray assembly being in a closed configuration.

FIG. 18 is a further perspective view of the tray assembly of FIG. 17, the tray being in an access configuration.

FIG. 19 is an exploded view of a portion of the tray assembly of FIG. 17.

FIG. 20 is a perspective view of one of the pieces of the tray assembly of FIG. 17.

FIG. 21 is a further perspective view of the piece of FIG. 20.

FIG. 22 is a perspective view of another of the pieces of the tray assembly of FIG. 17.

FIG. 23 is a further perspective view of the piece of FIG. 22.

FIG. 24 is a further perspective view of the piece of FIG. 22.

FIG. 25 is a further perspective view of the piece of FIG. 22.

FIG. 26 is a perspective view including the tray assembly of FIG. 17 pivotally attached to a tray support of an organizer and in an access configuration.

FIG. 27 is a perspective view of a further embodiment of a fiber management tray assembly according to the present disclosure, the tray assembly being in a closed configuration.

FIG. 28 is a further perspective view of the tray assembly of FIG. 27, the tray assembly being in a closed configuration.

FIG. 29 is a further perspective view of the tray assembly of FIG. 27, the tray assembly being in a closed configuration.

FIG. 30 is a further perspective view of the tray assembly of FIG. 27, the tray being in an access configuration.

FIG. 31 is an exploded view of a portion of the tray assembly of FIG. 27.

FIG. 32 is a further exploded view of a portion of the tray assembly of FIG. 27.

FIG. 33 is a perspective view of one of the pieces of the tray assembly of FIG. 27.

FIG. 34 is a further perspective view of the piece of FIG. 33.

FIG. 35 is a perspective view including the tray assembly of FIG. 27 pivotally attached to a tray support of an organizer and in an access configuration.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

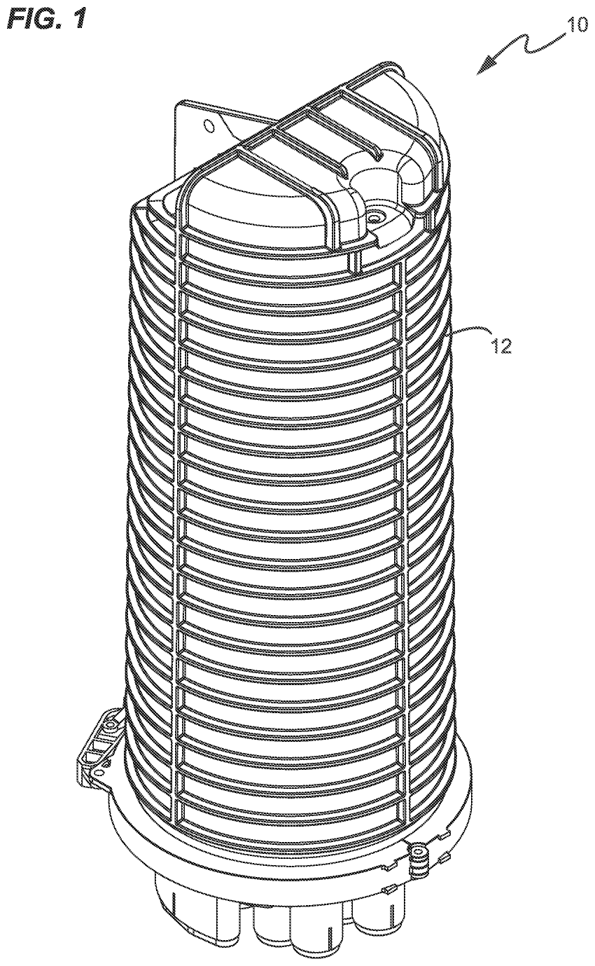

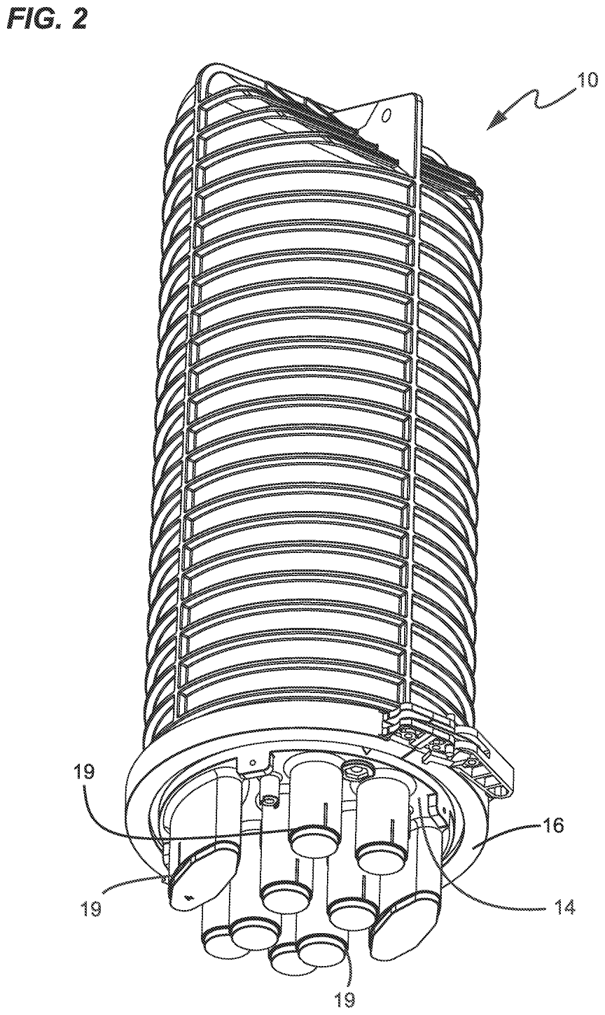

Referring to FIGS. 1-2, example telecommunications equipment 10 is shown. In the depicted example, the equipment 10 includes a sealable and re-enterable closure. In other examples, the equipment can include other components at a distribution location of an optical fiber network. Such equipment can include, for example, a cabinet, a drawer, a shelf, or a panel for organizing and routing optical fibers.

The closure 10 includes a first housing piece (or cover) 12 (in this case, a dome), and a second housing piece (or base) 14 configured to cooperate with the first housing piece to define a sealable and re-enterable telecommunications closure for managing optical fibers. The first and second housing pieces 12, 14 define a sealable and re-enterable interior closure volume in which other fiber managing equipment, including an optical fiber management organizer assembly (or “organizer”) according to the present disclosure, can be positioned.

A clamp ring 16 having a clamp can be used to clamp and seal together the housing pieces 12 and 14.

Cables carrying optical fibers can enter the closure volume via sealable ports 19 defined by the second housing piece 14. Such cables can include trunk cables, feeder cables, branch cables, and distribution cables (also known as drop cables). Typically, optical fibers from one cable entering the closure are spliced to optical fibers of one or more other cables entering the closure to establish an optical signal path at the closure 10 (or other signal distribution equipment) from a provider side cable to one or more customer side cables, or an optical signal between a branch cable and any of: another branch cable, a trunk cable, a feeder cable, or a distribution cable. Branch cables can be used to route optical signals from one telecommunications closure to another telecommunications closure.

In addition to splicing, other fiber management activities can be performed with telecommunications equipment housed within the closure volume. Such activities can include, without limitation, indexing fibers, storing fibers (typically in one or more loops), optically connecting two fibers, and splitting optical signals of a fiber at one or more signal splitters.

Splices, such as mechanical splices or fusion splices, can be performed at the factory or in the field, e.g., at the closure 10 positioned in the field.

Some of the optical fibers managed on the organizer can have connectorized ends. Connectorized fibers can be referred to as patch cords or pigtails. Such fibers can be optically connected to other connectorized fibers by mounting the connectors of the fibers to be optically connected on each side of an optical fiber adapter that is configured to align and optically connect the two optical fibers. Such optical fiber connectors can include ferrules having end faces at which the optical fibers terminate. Alternatively, such fibers can be ferrule-less. Non-limiting example of optical fiber connector form factors include SC, LC and MPO connectors.

Connecting optical fibers via connectors this way can be simpler than splicing the fibers. In addition, connectorized optical fibers can be easily optically connected to other connectorized optical fibers using adapters.

The cables entering the closure can include optical fibers of different configurations such as loose fibers and fiber ribbons. The fiber ribbons can be flat ribbons or rollable ribbons. The loose fibers can be individual fibers or bundled loose fibers protected by a common protective sheath or tube. For fiber ribbons, the fibers of the entire ribbon can be spliced to the fibers of a corresponding fiber ribbon at the same time, e.g., using a mass fusion splicing procedure.

Fibers extending from the ends of jacketed cables fixed to an organizer can be in protective sheaths, and the bare fibers extend from the ends of the sheaths, from which they can be routed to a fiber management tray of the organizer assembly for splicing, connector to connector optical coupling, splitting, or another fiber management operation.

Splice bodies can be used to protect the splices both in the case of individual fiber splices and mass fiber splices, such as mass fusion splices. The splice bodies are held in splice holders also known as splice chips. Fiber management trays of an organizer positioned in the interior sealable and re-enterable volume defined by the closure 10 can support such splice holders (or splice chips).

An organizer housed in the closure 10 can include fiber management trays configured to support splices, fiber management trays configured to support connector to connector optical connections, and/or fiber management trays that can support both one or more splices and one or more connector to connector connections.

For example, a feeder cable can enter a closure and its outer jacket can be affixed to the organizer within the closure. An optical fiber emerges from an end of the fixed jacket of the feeder cable. A free end of the feeder cable fiber is spliced to a connectorized pigtail and the splice is supported on a splice supporting fiber management tray of the organizer. Meanwhile, a drop cable can enter the same closure and its outer jacket can be affixed to the organizer within the closure. An optical fiber emerges from an of the fixed jacket of the drop cable. A free end of the drop cable fiber is spliced to another connectorized pigtail and the splice is supported on a splice supporting fiber management tray of the organizer, which can be the same tray on which the splice of the feeder cable is supported or a different tray. The two connectorized pigtails can then be routed to another tray that supports an optical fiber adapter having sockets into which which the two connectors are installed face to face, establishing optical continuity between the drop cable fiber and the feeder cable fiber.

An organizer housed in the closure 10 can be connected to the base 14. The organizer can be assembled in multiple configurations. A particular configuration can be selected, e.g., by a technician, based on one or more factors concerning fiber management needs at the closure 10, while taking into consideration the limited space capacity of the interior volume defined by the closure 10.

An organizer housed in the closure 10 can include one or more fiber management tray assemblies according to the present disclosure. Such tray assemblies can provide improved access to fiber management locations of fiber management trays than can be typical of other fiber management trays. An organizer of a closure such as the closure 10 typically will include a stack of fiber management trays, which is needed to handle splicing, splitting, connector to connector optical coupling, and/or other fiber management needs for the many optical fibers that are managed on the closure's organizer. The trays in the stack are pivotally mounted to the tray support, allowing access to the work surface of an individual tray by pivoting the trays in the stack above the individual tray away from it. However, due to the compact nature of the organizer, it can be challenging to access a portion of the individual tray that needs to be accessed even when the other trays are pivoted away, particularly the portion of the individual tray that is close to the pivot locations of the trays to the tray support. The tray assemblies of the present disclosure can improve access to the work surface of an individual tray in a stack of pivoting trays while still providing a compact tray assembly.

Pieces of the organizers described herein can be constructed of metal and/or polymeric materials. In some examples, one or more of the pieces are of unitary (e.g., seamless) construction. An organizer piece of unitary construction can be molded in a single molding operation.

As used herein, positioning and orientational terms such as up, down, upper, lower, above, below, front, back, rear, forward, backward, rearward, horizontal, vertical, proximal, distal, and so forth, may be used to refer to relative positioning of components in an assembly or portions of a component relative to each other when positioned in an assembly. Such terminology is provided as a descriptive aid and does not limit how components or portions of components may be positioned or oriented in practice.

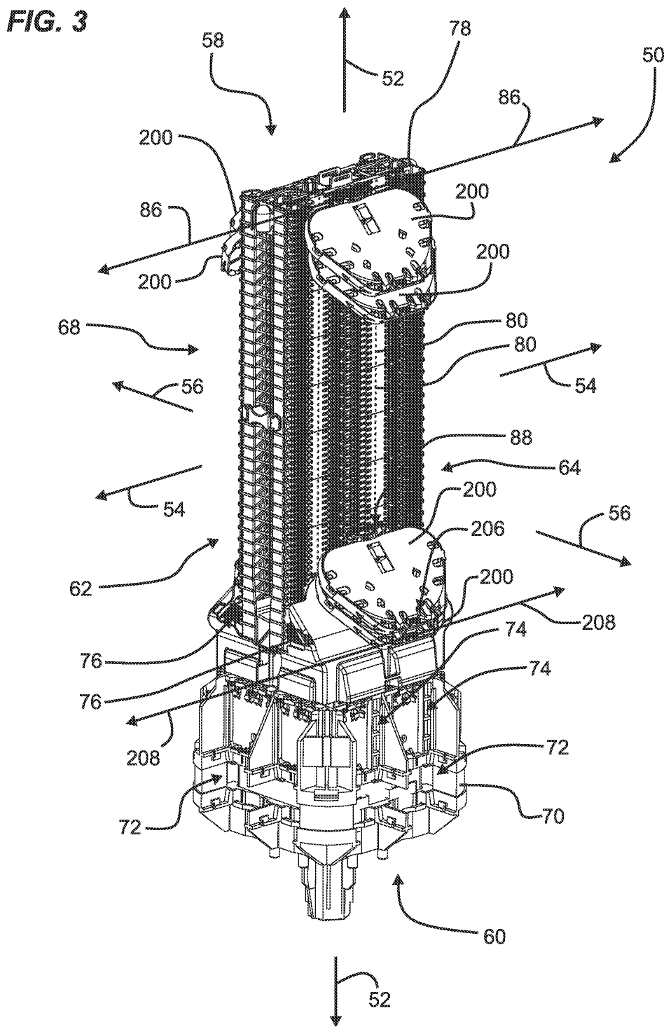

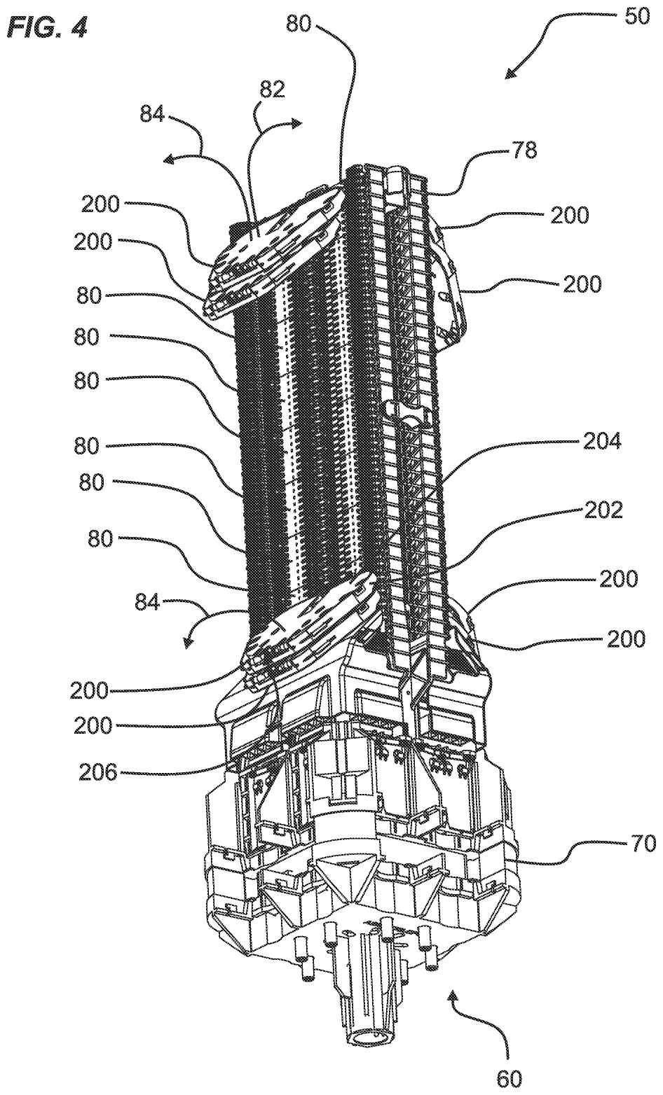

Referring to FIGS. 3-4, an organizer configuration 50 is shown. The organizer 50 can be housed in the closure 10 (FIG. 1).

The organizer 50 is an assembly of pieces. The organizer 50 extends along an axis 52 from a bottom 60 of the organizer to a top 58 of the organizer. The organizer extends along a second axis 54 from a first side 62 of the organizer to a second side 64 of the organizer. The organizer 50 extends along a third axis 56 from a back 68 of the organizer to a front 66 of the organizer. The axes 52, 54 and 56 are mutually perpendicular.

The organizer 50 includes a base 70. The base 70 defines pockets 72 for receiving seal blocks that can form seals around cable jackets entering the closure. The organizer 50 includes pockets 74 configured to mount plates of cable jacket fixation subassemblies. The cable jackets of cables entering the closure are fixed to the organizer 50 and the optical fibers emerge from the ends of the cable jackets and continue upward to other portions of the organizer 50 for further fiber management.

Above the base 70 at each of the front and the back of the organizer 50 is a fiber router 76. The fiber router 76 can include structures that guide fibers toward one side 62 or the other side 64 of the organizer. Each fiber router 76 can include sheath holders. Sheath holders are configured to fix portions of sheaths holding one or more loose optical fibers emerging from the cable jackets. Fixing of the cable jackets and fixing of the sheaths can reduce lateral load force on the cables or the sheaths from negatively impacting the delicate optical fibers they carry.

The two fiber routers 76 are back-to-back. Each fiber router is mounted to a framework 78. The framework 78 can include multiple frame members snap-connected to each other.

Mounted to the framework 78 above each fiber router 76 are modules 80. The modules 80 are arranged one atop another in a row on each of the front and the back of the framework 78. The modules 80 can be configured to snap-connect to the framework 78. The rows of the modules 80 are thus back-to-back. Each module 80 is a support configured to pivotally support fiber management trays and/or tray assemblies in a stack of the trays and/or tray assemblies. Thus, each module 80 can serve as a tray support for pivotally attaching fiber management trays and/or tray assemblies to the rest of the organizer 50. Specially, each module 80 includes receivers arranged parallel to the axis 52. Each receiver is configured to receive and pivotally attach to a complementary pin structure of a fiber management tray or tray assembly.

In the organizer 50, fiber management tray assemblies 200 are mounted in two stacks of two modules 80 at each of the front and the back of the framework 78.

The tray assemblies 200 are shown in a stacked configuration. Each stack is defined by a stacking axis that is parallel to the axis 52. Each tray assembly 200 is configured to be pivoted upward (e.g., in the direction of the arrow 82) from its stacked position to provide access to the tray assembly 200 immediately below it. Each tray assembly 200 is configured to pivot relative to the tray support 80 to which it is amounted about a pivot axis, or hinge axis 86, that passes through a center of the hinge defined by the receiver and of the tray support 80 and the pin of the tray assembly 200 that is received in the receiver. Each such hinge axis 86 is parallel to the axis 54.

Each tray assembly 200 includes a first piece 202 and a second piece 204. The second piece 204 is pivotally attached to the first piece 202 at a hinge 206. The hinge 206 is at an opposite end of the tray assembly 200 from the hinge 88 defined by the pivotal attachment of the tray assembly 200 and the corresponding module 80. The hinge 206 pivots about a hinge axis 208 that is parallel to the hinge axis 86 and parallel to the axis 54.

In FIGS. 3-4, each tray assembly 200 is shown in a closed configuration. Each second piece 204 may be pivoted using the hinge 206 about the hinge axis 208 in the direction of the arrow 84 to convert the tray assembly into an access configuration in which the components and features in the interior of the tray assembly when the tray assembly is in the closed configuration can be accessed.

For a given tray assembly 200, the direction of the arrow 82 is generally opposite to the direction of the arrow 84. For example, if the arrow 82 refers to a clockwise pivoting of the tray assembly 200 about the axis 86, then the arrow 84 refers to a counterclockwise pivoting of the second piece 204 about the axis 208, or vice versa.

Different embodiments of tray assemblies 100, 200 and 300 will now be described. However, the principles of how each tray assembly 100, 200 and 300 pivotally attach to a tray support (such as the tray support 80) and how the second piece of the assembly pivotally attaches to the first piece to allow for closed and access configurations of the tray assembly, are for each assembly 100, 200 and 300, consistent with the description above with respect to the tray assembly 200.

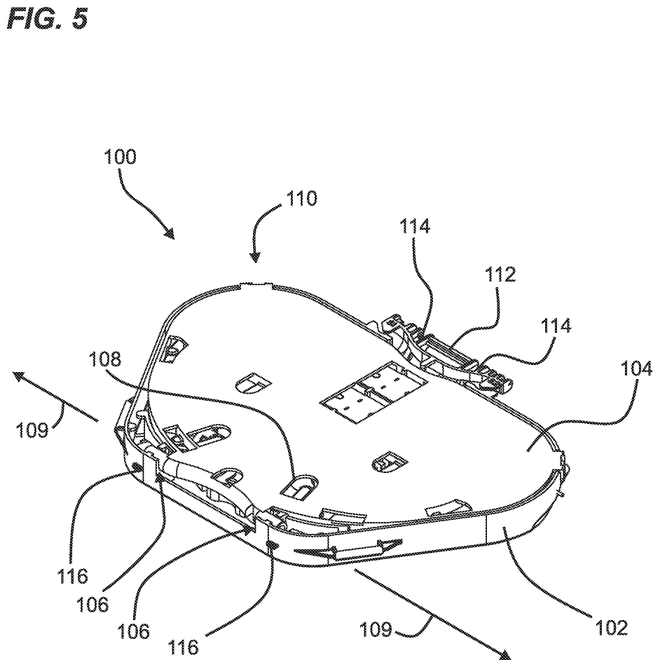

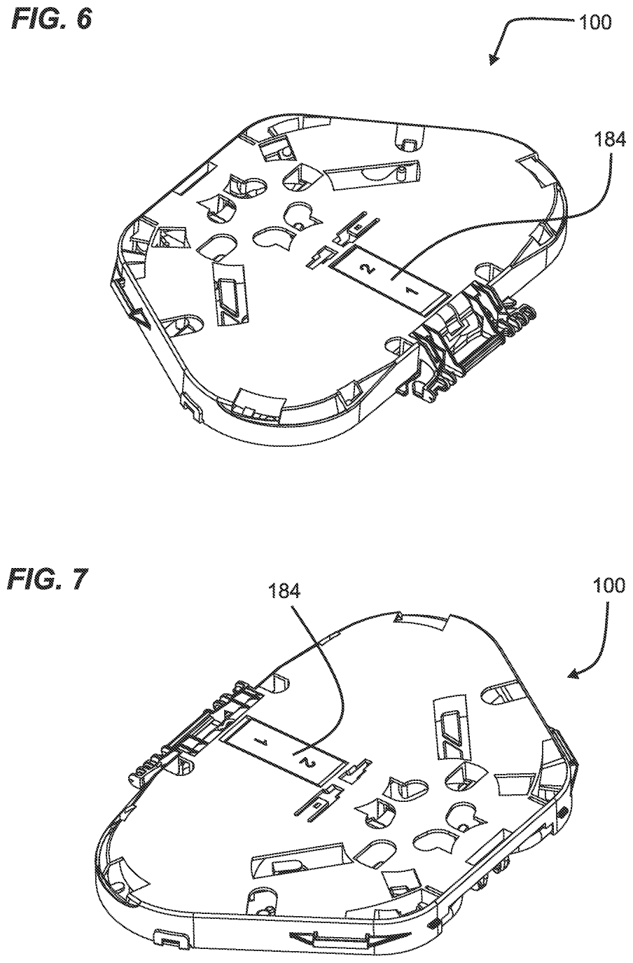

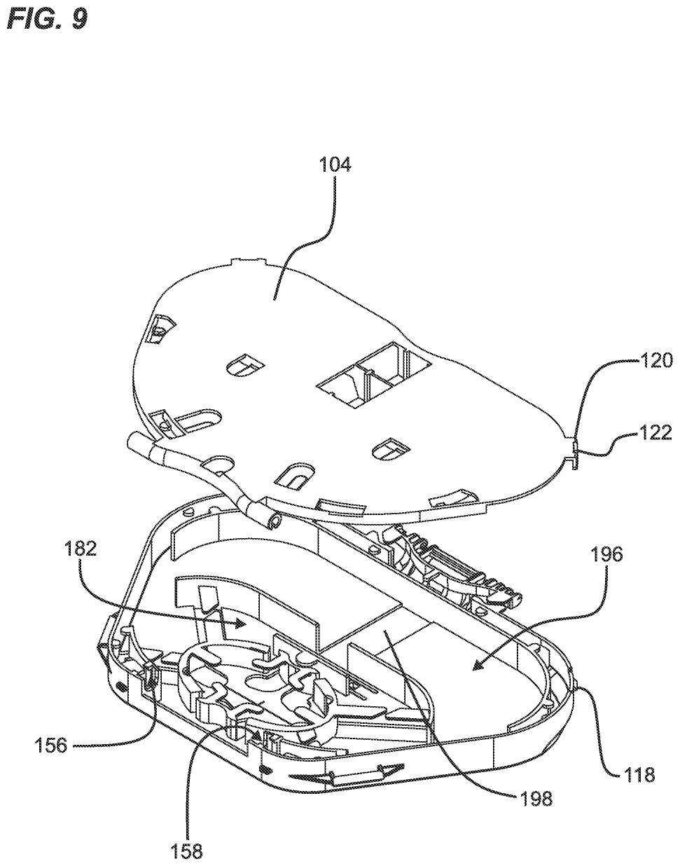

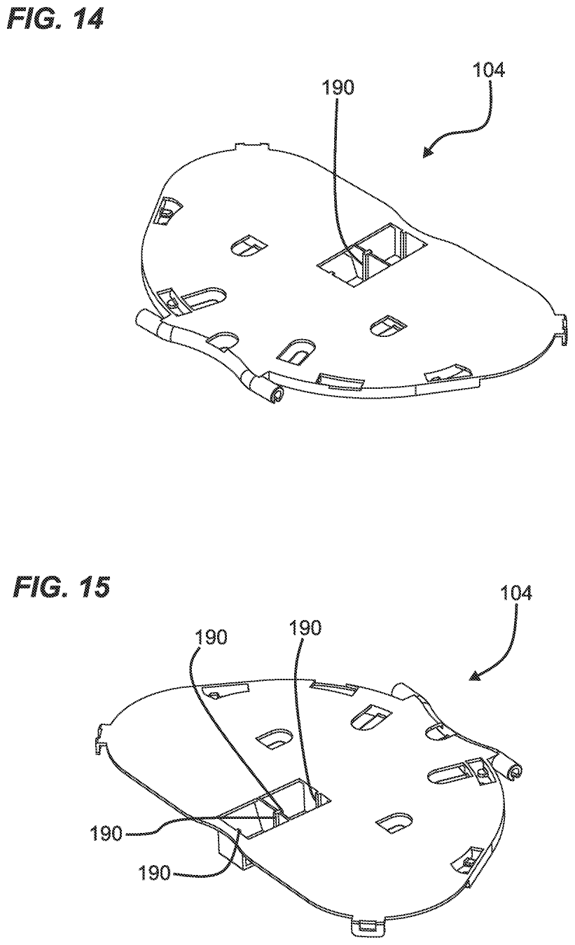

Referring to FIGS. 5-15, a first embodiment of a fiber management tray assembly 100 in accordance with the present disclosure will be described. The tray assembly 100 includes a first piece 102 and a second piece 104. When the tray assembly 100 is in a closed configuration, as shown in, e.g., FIG. 5, the assembly 100 has an interior 108 and an exterior 110. The interior 108 includes surfaces and structures for managing optical fibers within the interior 108.

The first piece 102 can be considered a fiber management tray and the second piece 104 can be considered a tray cover that can selectively cover the interior of the tray 102.

Each of the first piece 102 and the second piece 104 can be of unitary (e.g., seamless) construction.

The first piece includes a pin 112. The pin 112 is configured to be snappingly received in a receiver of a tray support 80 (FIGS. 3-4) to pivotally attach the tray assembly 100 to the tray support 80. In addition, the first piece includes posts 114 that can be pivotally received in complementary openings or recesses defined by the tray support 80 to further pivotally attach the tray assembly 100 to the tray support 80.

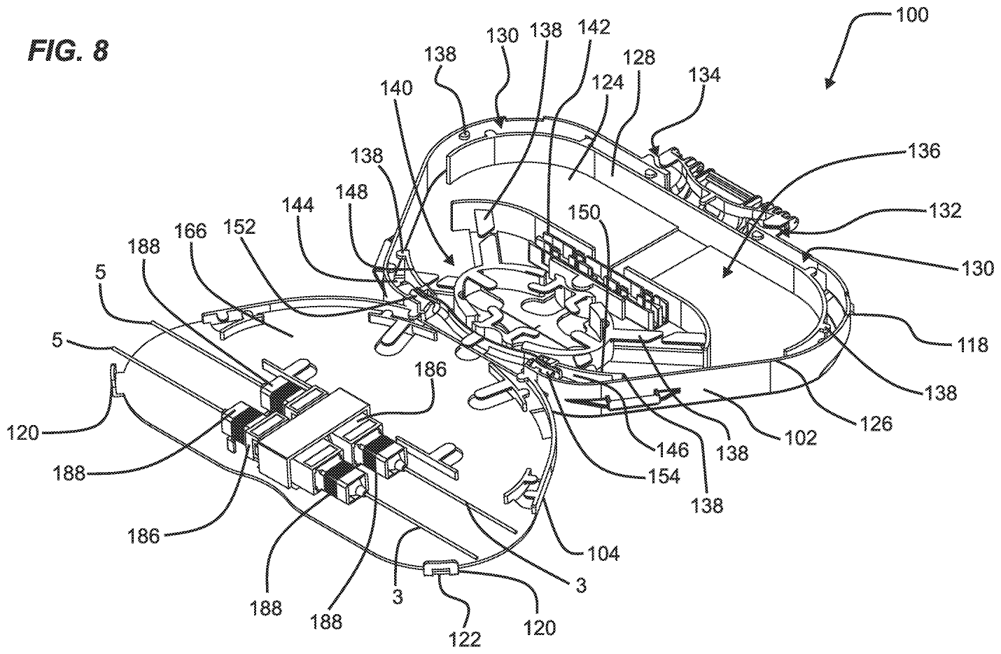

The first piece 102 and the second piece 104 are pivotally attached to each other at a hinge 106 that pivots about a pivot axis 109 between the closed configuration of the assembly 100 and the access configuration (FIG. 8).

The first piece 102 includes pivot stops 116 that contact the second piece 104 when the assembly 100 is in the access configuration, preventing further pivoting of the second piece away 104 away from the closed configuration of the assembly 100. Alternatively, the pivot stop(s) can be positioned and part of the second piece 104.

To optionally and releasably lock the assembly 100 in the closed configuration, the first piece and the second piece can include complementary locking elements. For example, the first piece 102 can include catches 118 that snapping engage tabs 120 within openings 122 defined by the tabs 120.

The first piece 102 includes a main work surface 124 at least partially surrounded by an outer perimeter wall 126 that projects perpendicularly away from the surface 124.

The wall 126 and a wall 128 define guide channels 130 for guiding optical fibers entering the interior 136 of the tray 102 via entryways 132 and 134. Retaining lips 138 projecting from the walls 126 and 128 can serve to retain optical fibers in the interior 136 of the tray 102, between the work surface 124 and undersides of the lips 138.

From the guide channels 130, optical fibers can be guided to a fiber routing structure 140, which includes retaining lips and guiding surfaces to route fibers in loops, partial loops, or S-shapes to redirect the fibers' path. The fiber routing structure 140 can also be used to store excess fiber slack in one or more loops in the region 182.

From the routing structure 140, the fibers can be guided to a splice holder 142 (e.g., a splice chip), which can be lockingly mounted to the surface 124. A protective splice body can be secured within a splice body receiver of the splice holder 142. The spliced fiber can then continue into one of the guide channels 144, 146.

The guide channel 144 is defined by the surface 124, the wall 126, a wall 148 and retaining lips 138. The guide channel 146 is defined by the surface 124, the wall 126, a wall 150, and retaining lips 138.

The guide channel 144 leads to a component 152 of the hinge 106. The component 152 is a portion of the cover 104 and is pivotally attached to the tray 102, with the component 152 being lockingly and pivotally received in a receiver 156 of the tray 102. The guide channel 146 leads to a component 154 of the hinge 106. The component 154 is a portion of the cover 104 and is pivotally attached to the tray 102, with the component 154 being lockingly and pivotally received in a receiver 158 of the tray 102.

The component 152 defines a fiber passage 160. The component 154 defines a fiber passage 162. Optical fibers can be routed onto the work surface 166 from the guide channels, 144, 146 via the fiber passages 160, 162. Thus, the fiber passages 160, 162, which allow optical fibers to be routed between the work surface 124 and the work surface 166, are included in and defined by the hinge components of the second piece 104 that pivotally attaches the first piece and the second piece.

Non-straight slots 168 can be provided in the hinge components 152, 154 to allow for lateral (rather than axial) fiber insertion into the hinge components 152, 154. Since the slots are not straight, the fibers can be retained within the hinge components 152, 154 without falling out when, e.g., the hinge rotates.

From the passages 160, 164, the fibers can routed along the work surface 166 via guide channels 170, 172. The guide channel 170 is defined by the surface 166, walls 173 and 174, and retaining lips 138. The guide channel 172 is defined by the surface 166, walls 176 and 178, and retaining lips 138.

The walls 173 and 176 are positioned at an outer perimeter of the surface 166. When the tray assembly 100 is in the closed configuration, the piece 104, including the walls 173, 176, is sized to nest within the interior 136 of the piece 102. In addition, when the tray assembly 100 is in the closed configuration, the surfaces 124 and 166 face each other.

From the guide channels 170, 172, fibers can be routed to a fiber management region 180 of the surface 166. The region 180 can include one or more fiber management components integral with, mounted to, and/or projecting from the surface 166. Such fiber management components can include splice holders, signal splitters, wave division multiplexers, and/or adapters configured to receive connectorized ends of optical fibers and optically couple the fiber ends to each other.

The region 180 of the piece 104 include one or more fiber management features in common with the fiber management region 182 of the piece 102. The fiber management region 182 in this example includes the routing structure 140 and the splice holder 142, but can include different and/or additional fiber management components, as described with respect to the region 180.

In the example piece 104 depicted, the region 180 includes a housing 184 projecting from the surface 166 toward the surface 124 when the assembly 100 is in the closed configuration. The housing 184 is configured to receive and mount, e.g., two optical fiber adapters 186. Each adapter 186 can be integral with, or otherwise attached to, the piece 104. Each adapter 186 is configured to optically connect two fibers 3, 5 via their optical fiber connectors 188 inserted into the adapter 186 at opposite ends of the adapter 186. Ribs 190, and/or other mounting features, can facilitate mounting adapters 186 within the housing 184. In the example shown, the connectors 188 are SC connectors.

The number and types of fiber management, and the corresponding fiber management structures, that can occur in the regions 180 and 182 can vary. One example use application of the tray assembly 100 is to have fibers (e.g., a feeder cable fiber and a drop cable fiber) entering the tray assembly via entryways 132, 134 spliced to connectorized pigtails with a splice body held in the splice holder 142, and the pigtails continuing from the work surface 124 via the channels 144 and 146, the passages 160 and 162, and the channels 170 and 172, on to the work surface 166 of the second piece 104 where their connectorized ends are optically connected to each other at an adapter 186 mounted to the adapter housing 184 of the second piece 104.

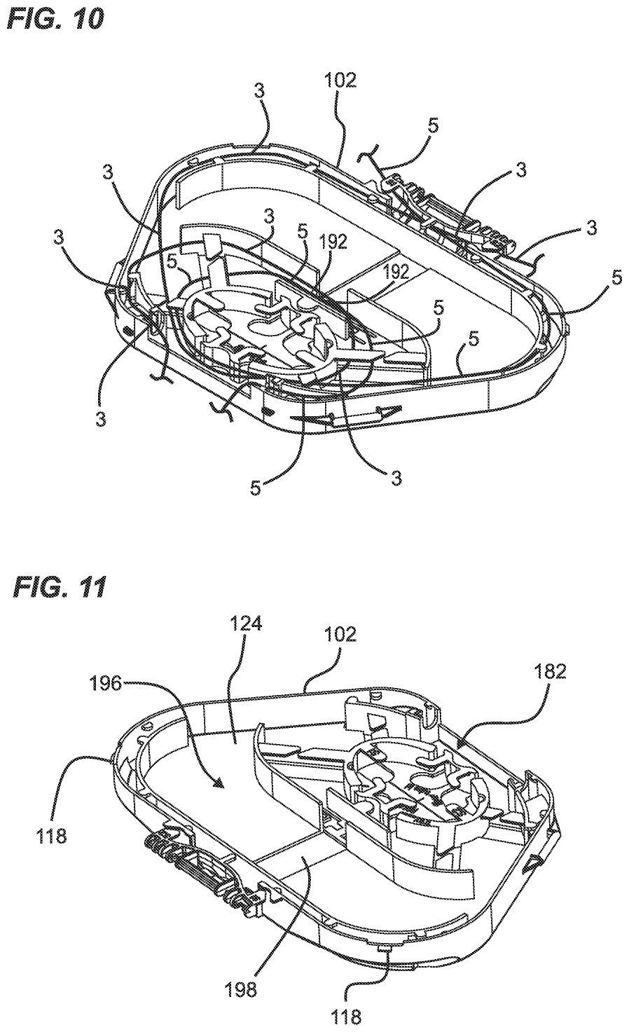

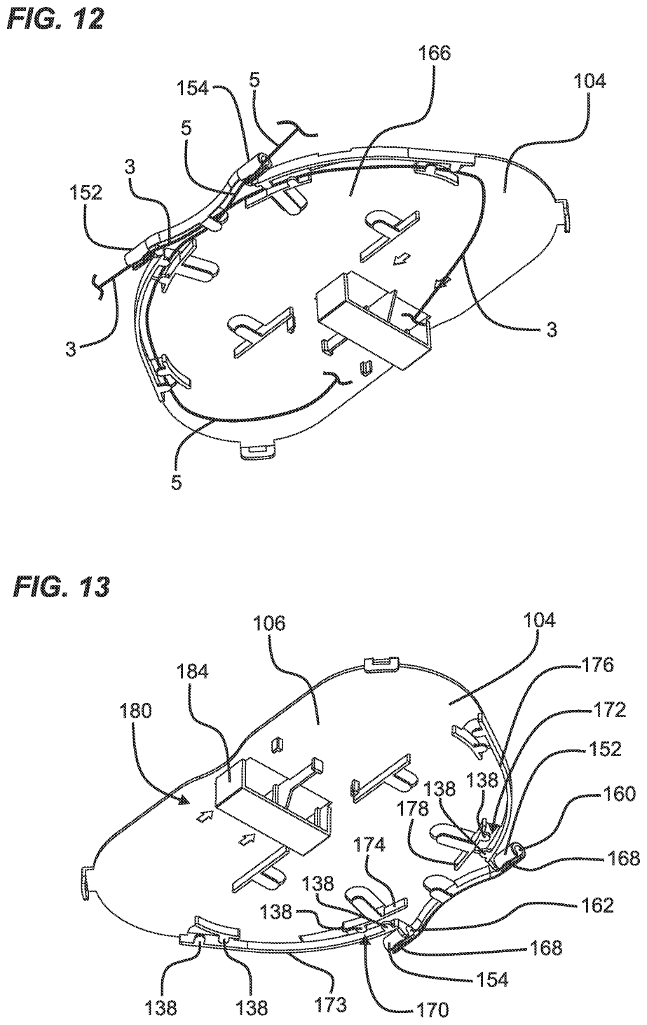

Referring to FIGS. 10 and 12, an example routing scheme for two optical fibers 3 and 5 is shown. The optical fibers can, in some examples, be a drop cable fiber and a feeder cable fiber, respectively. Each fiber enters the tray assembly 100 via an entryway 132, 134. Splices 192 of each of the fibers 3, 5 can be held in the splice holder 142 in the region 182 and from there continue to the piece 104, where their connectorized ends can be optically connected to each other at an adapter supported by the housing 184.

The first piece 102 defines an interior pocket 196. The pocket 196 is nearer to where the first piece 102 mounts to a tray support than is the region 182. The pocket 196 is largely void of structure so that it can receive the region 180 of the second piece 104 (e.g. void of connectors, adapters, and/or other fiber management components of the second piece 104) when the assembly 100 is in the closed configuration.

In addition, the work surface 124 of the first piece 102 can include a recess or material void 198 that can receive a portion of the housing 184 when the assembly 100 is in the closed configuration, thereby increasing the compactness of the assembly 100 in the closed configuration such that more such assemblies can be provided within the limited closure volume of a telecommunications closure, such as the closure 10 (FIG. 1).

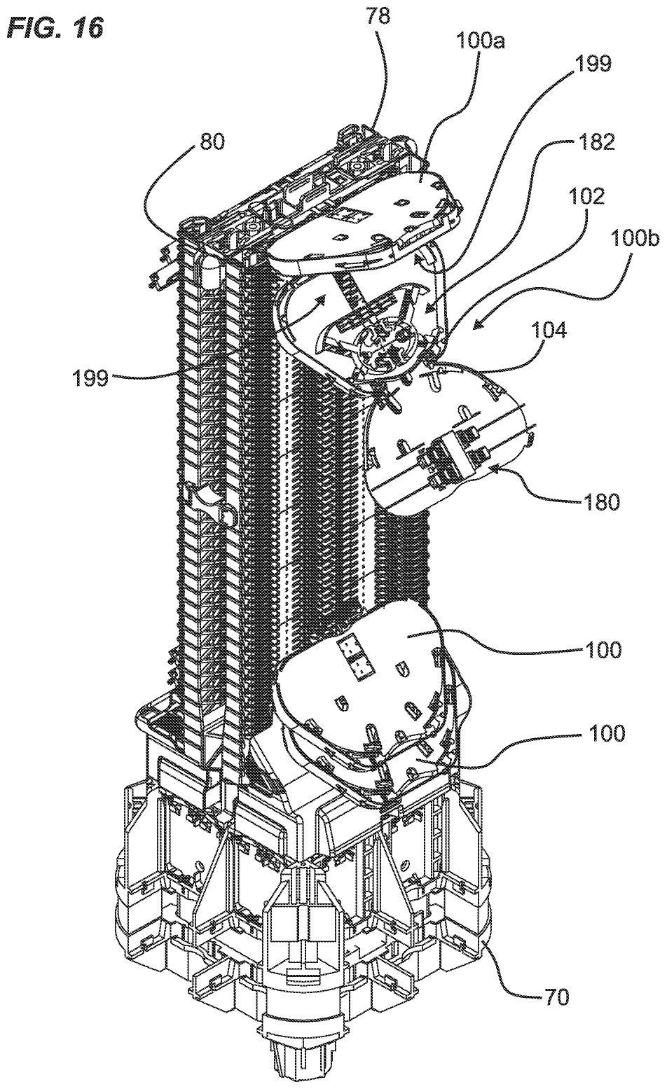

Due to the positioning of the regions 180 and 182, access to these regions (which is where most fiber management in the assembly 100 takes place) is improved when the assembly 100 is in the access configuration, as shown in FIG. 16. Referring to FIG. 16, the assembly 100a and the assembly 100b (which are each an assembly 100) are pivotally attached to a tray support 80 that is attached to the framework 78. The tray assembly 100a is in the closed configuration and has been pivoted upward relative to the tray support 80 to provide access to the tray assembly immediately below it, which is the tray assembly 100b. The tray assembly 100b is in the access configuration, with the piece 104 pivoted open relative to the piece 102.

It can be appreciated that the region 199 toward which the tray assemblies 100a and 100b are pivotally attached to the tray support 80 can be challenging to access to perform delicate fiber management, e.g., with fingers. Thus, the positioning of the regions 180 and 182 away from the region 199 improves access to the fiber management components of the assembly 100b.

When fiber management is complete, the piece 104 can be pivotally closed, and then the tray assembly 100a can be pivoted down into the stacked configuration with the tray assembly 100b for installation into the closure volume.

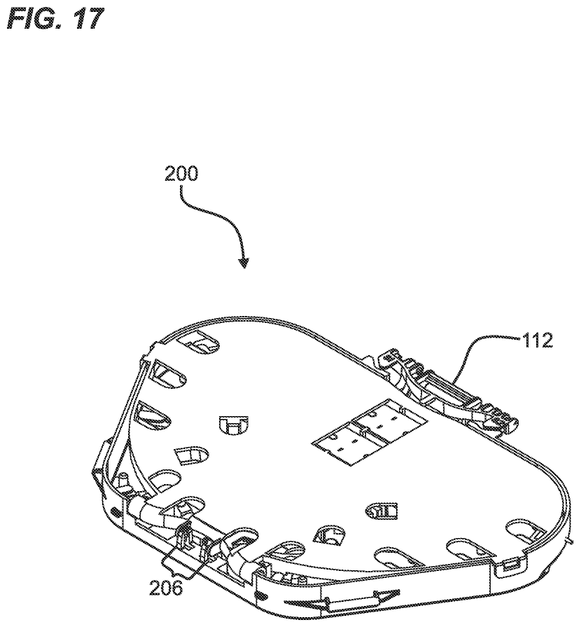

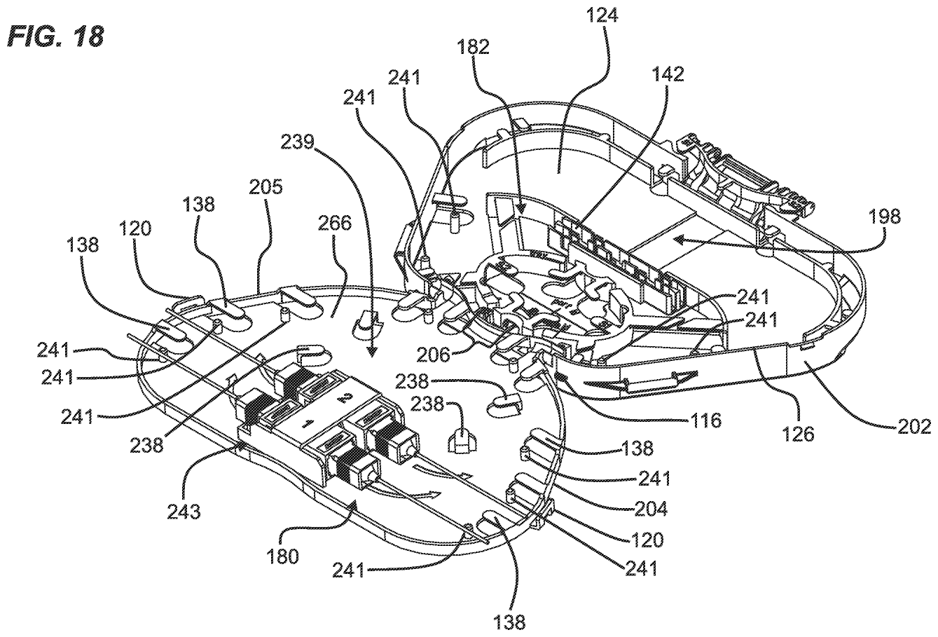

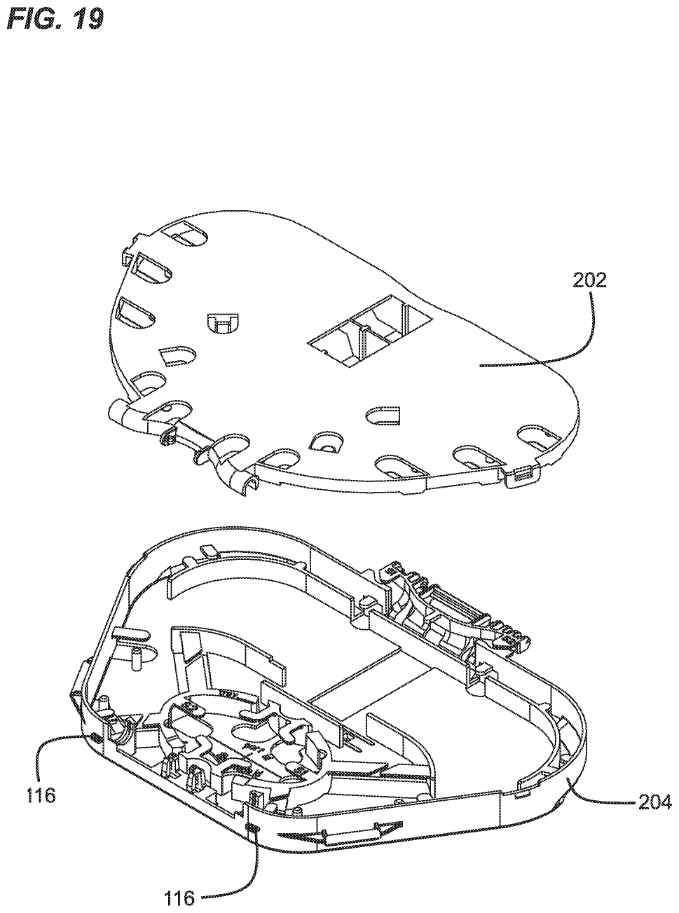

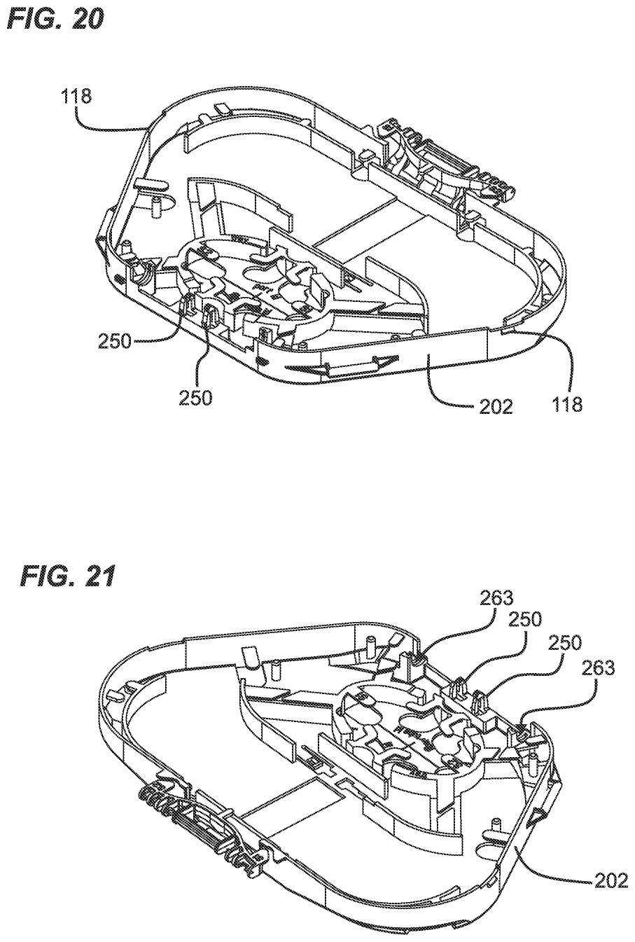

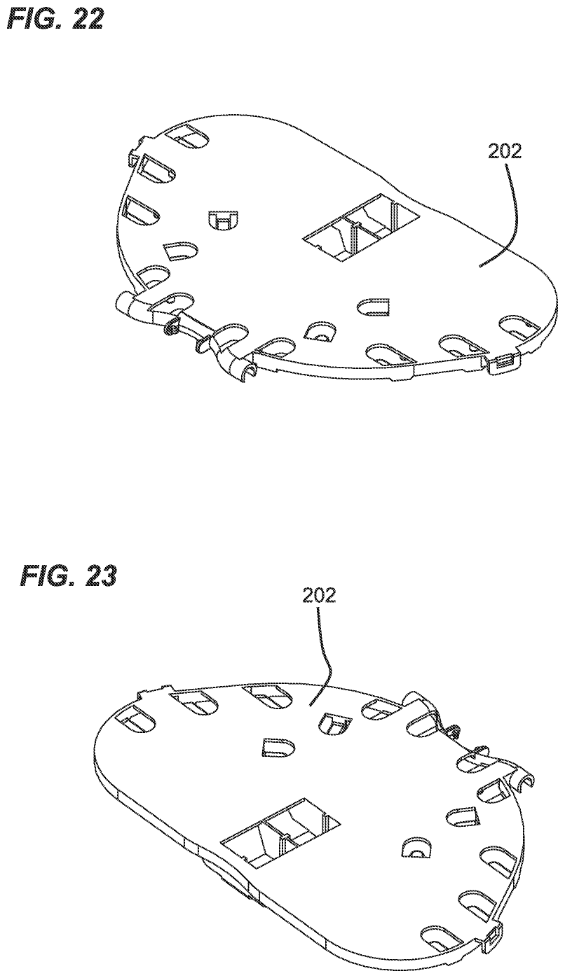

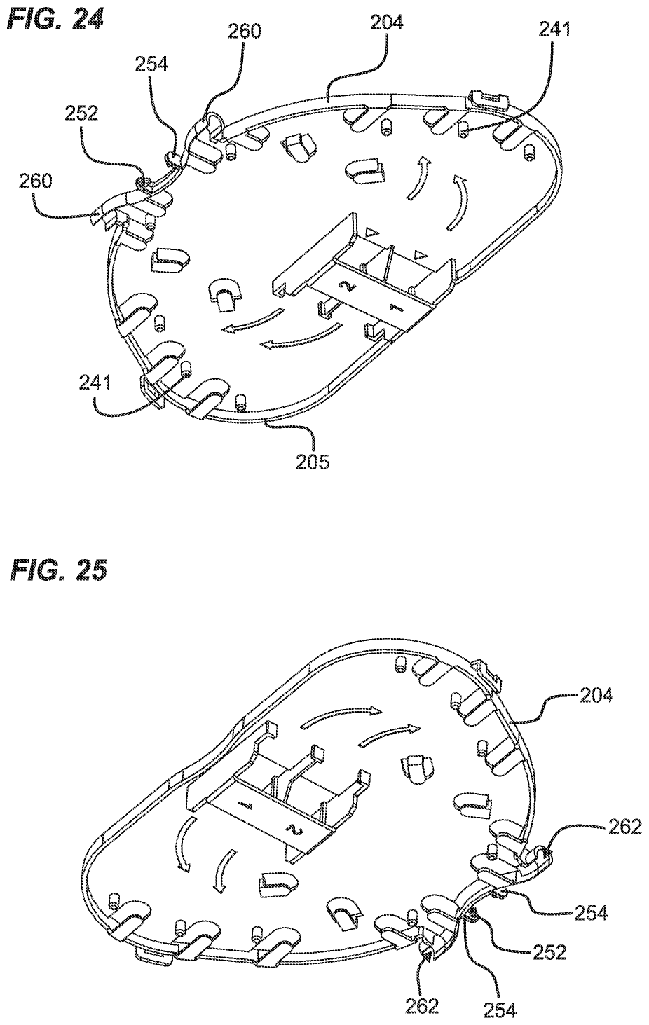

Referring to FIGS. 17-25, the tray assembly 200 will be described. The assembly 200 includes many features and functions in common with the assembly 100 that are apparent from the drawings. In the interest of brevity, a description of the tray assembly 200 will be limited largely to features that differ from the assembly 100.

The piece (or cover) 204 includes an outer perimeter wall 205 that surrounds more of the work surface 266 than do the corresponding walls 174 and 176 about the work surface 166 of the corresponding piece (or cover 104) of the assembly 100.

In addition to fiber retaining lips 138, the piece 204 includes additional fiber retaining lips 238 which retain fiber slack in one or loops in a region 239 of the piece 204 and between the surface 266 and the lips 238.

The piece 204 also includes posts 241 projecting from the surface 266. The posts can also be used to guide optical fibers along the surface 266. For example, the posts 241 and the wall 205 can define a channel for routing fibers about an outer perimeter of the surface 166, e.g., via a channel 243. The piece 202 also includes such posts.

The wall 205 is configured to be nested entirely within the interior of the tray 202 and within the wall 126 when the assembly 200 is in the closed configuration.

Though the general location and function of the pivotal attachment of the pieces 202 and 204 differs from the pivotal attachment of the pieces 102 and 104, the hinge 206 differs from the hinge 106 in that the hinge 206 that pivotally attaches the pieces 202 and 204 to each other does not define the passages that guide optical fibers from the surface 124 to the surface 266 (i.e., from the piece 202 to the piece 204). Rather, the hinge 206 provides a pivotal attachment between the pieces 202 and 204 that is separate from those passages.

More specifically, the hinge 206 includes receivers 250 of the piece 202 that have openings into which pins 252 of the piece 204 pivotally lock, e.g., by inserting the pins 252 into resiliently flexing tabs 254 from which the pins 252 project toward each other when attached to the receivers 250.

Opposing guide channels on the work surface 166 lead to components 260 of the piece 204. The components 260 are on either side of the pins 252. Each component 260 defines a fiber passage 262 that can guide fibers from the piece 202 on the piece 204. The components 260 are pivotally received in receivers 263 of the first piece 202.

Because the components 260 are not required to attach the pieces 202 and 204 together, the passages 262 can be larger and more open than the passages 160, 162, which can reduce undesirable twisting of optical fibers in the passages when the piece 204 is pivoted relative to the piece 202. Fiber retention can be achieved with fiber retention lips.

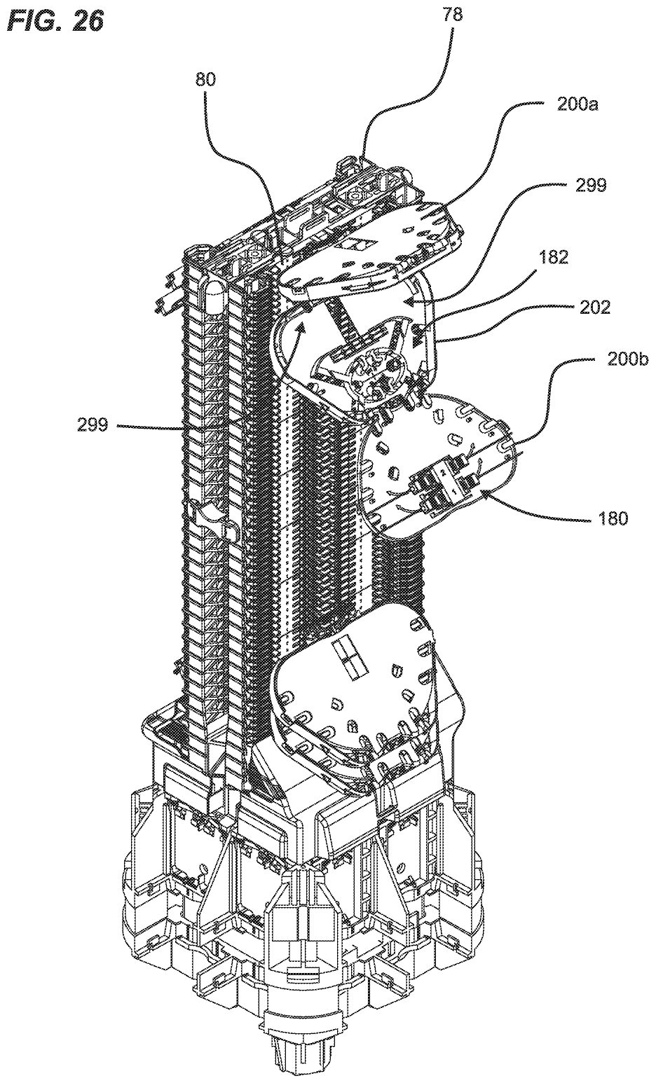

Due to the positioning of the regions 180 and 182, access to these regions (which is where most fiber management in the assembly 200 takes place) is improved when the assembly 200 is in the access configuration, as shown in FIG. 26. Referring to FIG. 26, the assembly 200a and the assembly 200b (which are each an assembly 200) are pivotally attached to a tray support 80 that is attached to the framework 78. The tray assembly 200a is in the closed configuration and has been pivoted upward relative to the tray support 80 to provide access to the tray assembly immediately below it, which is the tray assembly 200b. The tray assembly 200b is in the access configuration, with the piece 204 pivoted open relative to the piece 202.

It can be appreciated that the region 299 toward where the tray assemblies 200a and 200b are pivotally attached to the tray support 80 can be challenging to access to perform delicate fiber management, e.g., with fingers. Thus, the positioning of the regions 180 and 182 away from the region 299 improves access to the fiber management components of the assembly 200b.

When fiber management is complete, the piece 204 can be pivotally closed, and then the tray assembly 200a can be pivoted down into the stacked configuration with the tray assembly 200b.

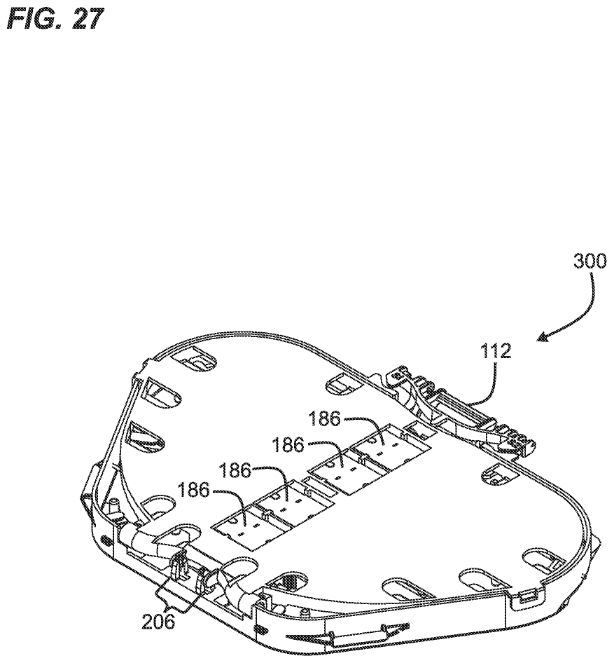

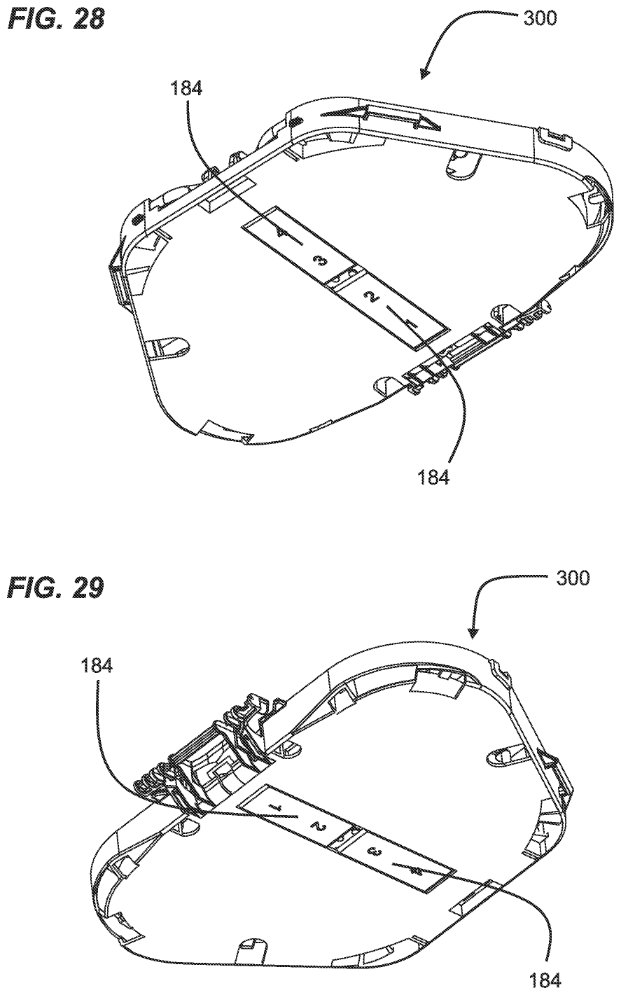

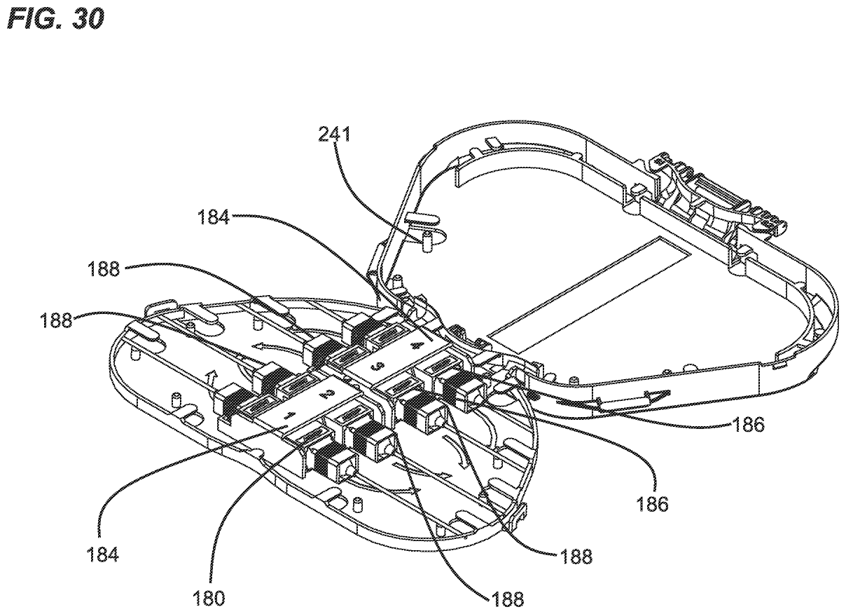

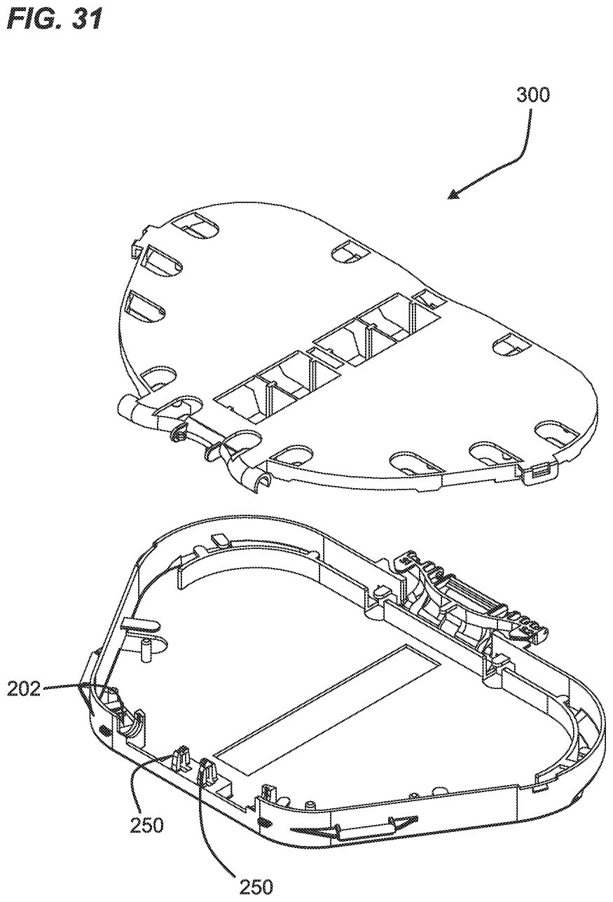

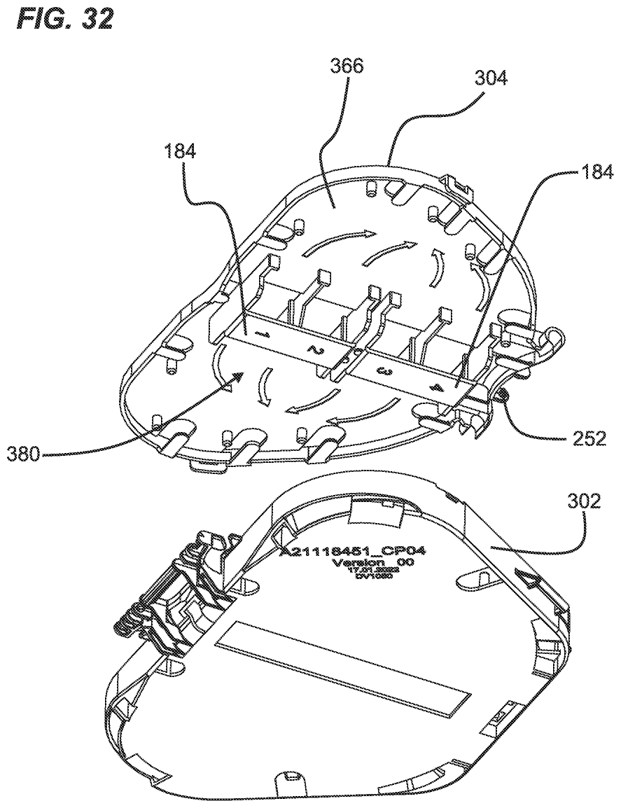

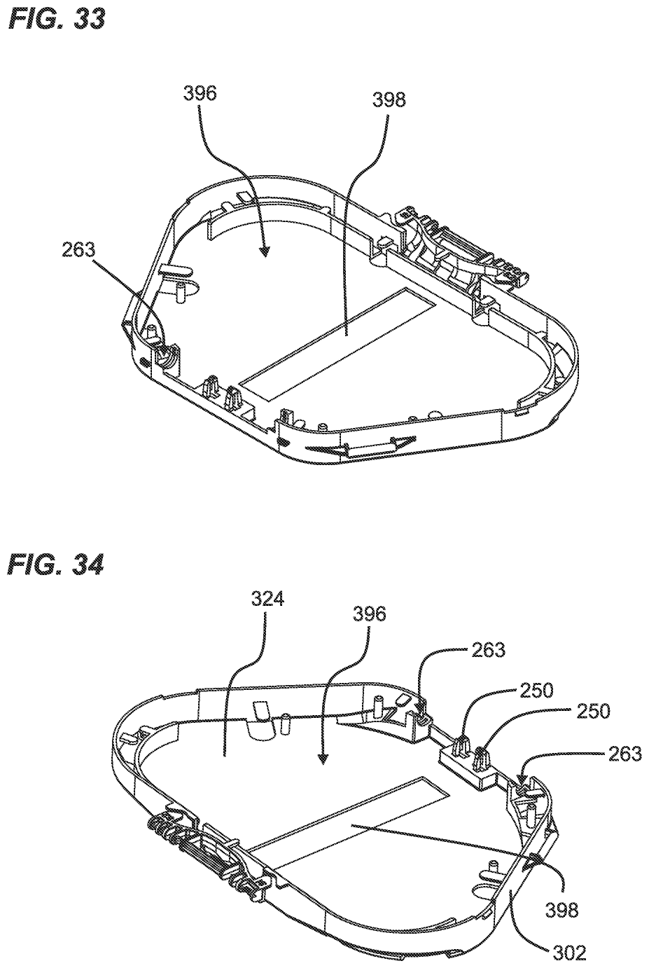

Referring to FIGS. 27-34, the tray assembly 300 will be described. The assembly 300 includes many features and functions in common with the assembly 200 and the assembly 100 that are apparent from the drawings. In the interest of brevity, a description of the tray assembly 300 will be limited largely to features that differ from the assembly 200.

The tray assembly 300 includes pieces 302 and 304 that pivotally attach to each other at a hinge 206 (the same hinge construction as between the pieces 202 and 204 of the tray assembly 200).

Unlike the tray assemblies 100 and 200, other than fiber routing, all fiber management that takes place on the tray assembly 300 (and in the interior of the tray assembly 300 when the tray assembly 300 is in the closed configuration) takes places on the second piece (or cover) 304, and not on the first piece (or tray) 302.

The fiber management region 380 of the piece 304 includes housings 184 integral with, or attached to, the work surface 366 that can support more adapters (and therefore more connector-to-connector connections of pigtails) than either of the tray assemblies 100, 200. In particular, the housings 184 of the piece 304 can support up to four SC adapters.

In complementary fashion, the interior pocket 396 defined by the work surface 324 of the piece 302 is more devoid of structure than the pocket 196, and is sized to receive all four adapters 186, both housings 184, and all eight SC connectors 188 when the tray assembly 300 is in the closed configuration. Similarly, the material void 398 is larger than the material void 198 to accommodate both housings 184.

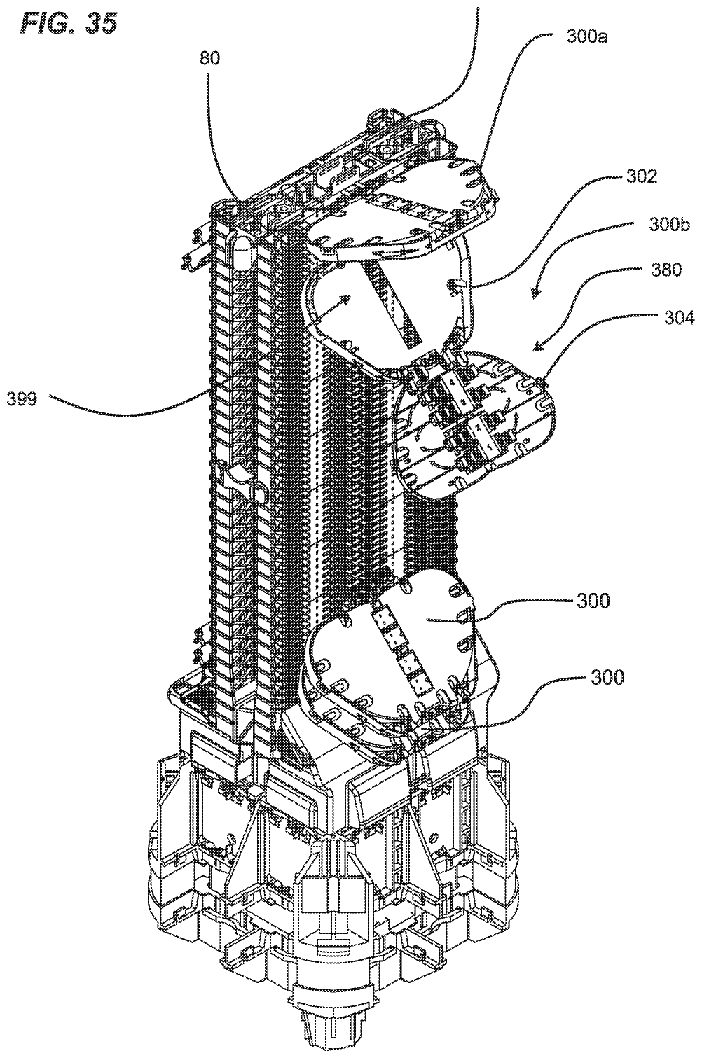

Due to the positioning of the region 380, access to the region (which is where most fiber management in the assembly 300 takes place) is improved when the assembly 300 is in the access configuration, as shown in FIG. 35. Referring to FIG. 35, the assembly 300a and the assembly 300b (which are each an assembly 300) are pivotally attached to a tray support 80 that is attached to the framework 78. The tray assembly 300a is in the closed configuration and has been pivoted upward relative to the tray support 80 to provide access to the tray assembly immediately below it, which is the tray assembly 300b. The tray assembly 300b is in the access configuration, with the piece 304 pivoted open relative to the piece 302.

It can be appreciated that the region 380 toward where the tray assemblies 300a and 300b are pivotally attached to the tray support 80 can be challenging to access to perform delicate fiber management, e.g., with fingers. Thus, the positioning of the region 380 away from the region 399 improves access to the fiber management components of the assembly 200b. Moreover, because the entirety of the fiber management region 399 is on the cover 304, the tray assembly 300 can provide overall even more improved access than the tray assemblies 100 or 200.

The tray assembly 300, unlike the assemblies 100 and 200 does not support optical fiber splices. According to example organizer embodiments, a stack of fiber management trays pivotally supported by the framework 79 includes tray assemblies 300 and other trays that support splices. Optical fibers from cables are routed to the splice trays where their splices to connectorized pigtails are supported, and the connectorized ends of the fibers are routed to a tray assembly 300 where the connectors are installed in adapters to form optical connections.

Various modifications and alterations of this disclosure will become apparent to those skilled in the art without departing from the scope and spirit of this disclosure, and it should be understood that the scope of this disclosure is not to be unduly limited to the illustrative examples set forth herein.

What is claimed:

1. An optical fiber management tray assembly, comprising:
a closed configuration defining an assembly interior and an assembly exterior;
an access configuration;
a first piece configured to pivotally attach to a tray support and including a first interior work surface; and
a second piece pivotally attached to the first piece and including a second interior work surface, the first interior work surface and the second interior work surface defining the assembly interior and facing each other when the assembly is in the closed configuration; and
a fiber management component integral with or attached to the second interior work surface, the fiber management component being:
positioned in the assembly interior when the assembly is in the closed configuration; and
accessible when the assembly is in the access configuration.

2. The assembly of claim 1,
wherein the fiber management component includes a splice holder.

3. The assembly of claim 1, wherein the fiber management component includes a fiber routing structure or a fiber retaining lip.

4. The assembly of claim 1, wherein the fiber management component includes an adapter configured to optically couple optical fibers terminated at optical fiber connectors when the connectors are mounted in the adapter.

5. The assembly of claim 4, wherein the first piece includes a recess or a material void within the first interior work surface, the adapter or a housing of the adapter being positioned in the recess or the material void when the assembly is in the closed configuration.

6. The assembly of any of claims 1-5, wherein another fiber management component is integral with or attached to the first interior work surface.

7. The assembly of claim 6, wherein the another fiber management component includes a splice holder, a fiber routing structure, a fiber retaining lip, or an adapter configured to optically couple optical fibers terminated at optical fiber connectors when the connectors are mounted in the adapter.

8. The assembly of any of claims 1-7, wherein at least a portion of the second piece nests within an outer wall of the first piece when the assembly is in the closed configuration.

9. The assembly of any of claims 1-8, wherein the first piece and the second piece include complementary locking elements to releasably lock the first piece and the second piece together in the closed configuration.

10. The assembly of any of claims 1-9,
wherein the first piece is configured to pivotally attach to the tray support at a first hinge; and
wherein the second piece is pivotally attached to the first piece at a second hinge.

11. The assembly of claim 10, wherein the first hinge and the second hinge are at opposite ends of the assembly when the assembly is in the closed configuration and pivotally mounted to the support structure.

12. The assembly of any of claims 10-11, wherein the second hinge includes a fiber passage for routing an optical fiber through the fiber passage between the first interior work surface and the second interior work surface.

13. The assembly of any of claims 10-11, wherein the first piece and/or the second piece includes a fiber passage for routing an optical fiber through the fiber passage between the first interior work surface and the second interior work surface.

14. The assembly of claim 13, wherein the fiber passage is not defined by the second hinge.

15. The assembly of any of claims 1-14, further comprising a pivot stop configured to hinder pivoting of the second piece from the access configuration further away from the closed configuration.

16. The assembly of any of claims 1-15,
wherein the first piece is a fiber management tray; and
wherein the second piece is a tray cover for covering an interior of the fiber management tray.

17. The assembly of any of claims 1-16, wherein the first piece defines fiber entryways for routing optical fibers from off the assembly onto the first interior work surface.

18. The assembly of any of claims 1-17, further comprising the tray support, wherein the tray assembly is pivotally attached to the tray support in a stack of trays, each of the trays being pivotally attached to the tray support.

19. A telecommunications closure, comprising,
first and second housing pieces configured to define a sealable and re-enterable closure volume;
the assembly of claim 18 positioned in the closure volume; and
an optical cable entering the closure, an outer jacket of the cable being fixed within the closure volume, an optical fiber of the cable being routed to the first interior work surface and the second interior work surface.

20. The closure of claim 19, wherein the optical fiber includes a splice between a portion of the optical fiber extending from the cable and another portion of the fiber that is connectorized with a fiber optic connector.

21. The closure of claim 20, wherein the fiber optic connector is a SC connector.

22. The closure of any of claims 20-21, wherein the splice is supported on one of the trays in the stack.

23. A method of using the assembly of claim 18, comprising:
pivoting one of the trays in the stack in a clockwise or counterclockwise direction relative to the tray support; and, subsequent thereto,
pivoting the second piece in the other of the clockwise or counterclockwise direction relative to the first piece to access the second interior work surface.

24. An optical fiber management tray assembly, comprising:
a closed configuration defining an assembly interior and an assembly exterior;
an access configuration;
a first piece configured to pivotally attach to a tray support and including a first work surface and a first fiber retaining lip for retaining an optical fiber between the first work surface and the first fiber retaining lip; and
a second piece pivotally attached to the first piece at a hinge positioned at or exterior to an outer wall of the second piece and positioned at or exterior to an outer wall of the first piece, the second piece including a second surface and a second fiber retaining lip for retaining the optical fiber between the second work surface and the second fiber retaining lip,
wherein the second piece includes a fiber passage for routing the optical fiber through the fiber passage from the first work surface to the second work surface; and
wherein the fiber passage is not defined by the hinge.

25. The assembly of claim 24,
wherein the first piece is a fiber management tray; and
wherein the second piece is a tray cover for covering an interior of the fiber management tray.

26. The assembly of any of claims 24-25, wherein at least a portion of the second piece nests within the outer wall of the first piece when the assembly is in the closed configuration.

27. The assembly of any of claims 24-26, wherein the first piece and the second piece include complementary locking elements to releasably lock the first piece and the second piece together in the closed configuration.

28. The assembly of any of claims 24-27,
wherein the first piece is configured to pivotally attach to the tray support at another hinge; and
wherein the hinge and the another hinge are at opposite ends of the assembly when the assembly is in the closed configuration and pivotally mounted to the support structure.

29. The assembly of any of claims 24-28, further comprising a pivot stop configured to hinder pivoting of the second piece from the access configuration further away from the closed configuration.

30. The assembly of any of claims 24-29, wherein the first piece defines fiber entryways for routing optical fibers from off the assembly onto the first work surface.

31. An optical fiber management tray assembly, comprising:
a closed configuration defining an assembly interior and an assembly exterior;
an access configuration;
a first piece configured to pivotally attach to a tray support and including a first work surface and a fiber retaining lip for retaining an optical fiber between the first work surface and the fiber retaining lip; and
a second piece pivotally attached to the first piece at a hinge positioned at or exterior to an outer wall of the second piece and positioned at or exterior to an outer wall of the first piece; and
an adapter integral with or attached to the second piece, the adapter being configured to optically couple optical fibers terminated at optical fiber connectors when the connectors are installed in the adapter.

32. The assembly of claim 31, wherein the first piece includes a recess or a material void within the first work surface, the adapter or a housing of the adapter being positioned in the recess or the material void when the assembly is in the closed configuration.

33. The assembly of any of claims 31-32,
wherein the first piece is a fiber management tray; and
wherein the second piece is a tray cover for covering an interior of the fiber management tray.

34. The assembly of any of claims 31-33, wherein at least a portion of the second piece nests within the outer wall of the first piece when the assembly is in the closed configuration.

35. The assembly of any of claims 31-34, wherein the first piece and the second piece include complementary locking elements to releasably lock the first piece and the second piece together in the closed configuration.

36. The assembly of any of claims 31-35,
wherein the first piece is configured to pivotally attach to the tray support at another hinge; and
wherein the hinge and the another hinge are at opposite ends of the assembly when the assembly is in the closed configuration and pivotally mounted to the support structure.

37. The assembly of any of claims 31-36, wherein the first piece defines fiber entryways for routing optical fibers from off the assembly onto the first work surface.
